(19) United States
(12) Patent Application Publication
(10) Pub. No.: US 2025/0370674 A1
(43) Pub. Date: Dec. 4, 2025

(54) IMAGE FORMING APPARATUS, METHOD, AND STORAGE MEDIUM STORING PROGRAM

(71) Applicant: CANON KABUSHIKI KAISHA, Tokyo (JP)

(72) Inventors: Ryuhei Wakita, Tokyo (JP); Moritaka Iwakoshi, Kanagawa (JP); Takanobu Suzuki, Kanagawa (JP); Kazunari Shishido, Kanagawa (JP)

(21) Appl. No.: 19/216,794

(22) Filed: May 23, 2025

(30) Foreign Application Priority Data
Jun. 4, 2024 (JP) 2024-090921

(51) Int. Cl. G06F 3/12; B41J 3/60

(52) U.S. Cl. CPC G06F 3/1252; B41J 3/60; G06F 3/1254

(57) ABSTRACT

An image forming apparatus includes: an acquisition unit configured to acquire print data and print setting information; a data control unit configured to control assignment to each hierarchical layer in multilayer printing based on presence/absence of data corresponding to at least any of a front surface and a back surface in the print data when double-sided printing is set for the print data in the print setting information; a generation unit configured to generate image data by executing image processing on hierarchical data on which the assignment is performed under control by the data control unit; and a print control unit configured to control a print unit so as to perform printing by the multilayer printing on a print medium based on the image data generated by the generation unit.

### BACKGROUND

### Field of the Technology

The present disclosure relates to an image forming apparatus that can execute multilayer printing, a method, and a storage medium storing a program.

### Description of the Related Art

It is known that a first print image, a second print image that shields the first print image, and a third print image overlapping with the second print image are formed on a print medium such as a transparent window glass or film, whereby the first print image and the third print image can be visually recognized respectively from both sides of the print medium. Japanese Patent Laid-Open No. 2014-166762 describes a control method for performing printing by overlapping the first print image, the second print image that shields the first print image, and the third print image. Furthermore, it is known that the first print image and the second print image that shields the first print image are formed on the print medium in an overlapping manner, whereby the print image can be visually recognized only from the back surface of the print medium. It is known that the second print image that shields a print image and the third print image overlapping with the second print image are formed on the print medium, whereby the print image can be visually recognized only from the front surface of the print medium.

### SUMMARY

The present disclosure provides an image forming apparatus, a method, and a program for controlling multilayer printing so as to output a printed matter equivalent to that in a case of performing double-sided printing, based on presence/absence of data corresponding to each of a front surface and a back surface in print data for which double-sided printing is designated.

The present disclosure in one aspect provides an image forming apparatus comprising: at least one memory and at least one processor which function as: an acquisition unit configured to acquire print data and print setting information; a data control unit configured to control assignment to each hierarchical layer in multilayer printing based on presence/absence of data corresponding to at least any of a front surface and a back surface in the print data when double-sided printing is set for the print data in the print setting information; a generation unit configured to generate image data by executing image processing on hierarchical data on which the assignment is performed under control by the data control unit; and a print control unit configured to control a print unit so as to perform printing by the multilayer printing on a print medium based on the image data generated by the generation unit.

According to the present disclosure, it is possible to control multilayer printing so as to output a printed matter equivalent to that in a case of performing double-sided printing, based on presence/absence of data corresponding to each of a front surface and a back surface in print data for which double-sided printing is designated.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating a configuration of an image forming apparatus.

FIG. 2 is a view illustrating an appearance of the image forming apparatus.

FIG. 3 is a view illustrating an appearance of the image forming apparatus.

FIG. 4 is a schematic cross-sectional view of a periphery of a print mechanism of the image forming apparatus.

FIG. 5 is a view illustrating a functional block configuration of a printer controller.

FIG. 6 is a flowchart showing processing of the printer controller.

FIG. 7 is a view illustrating an example of a multilayer printing setting screen.

FIGS. 8A to 8C are views for describing a printed matter in a case where multilayer printing is performed.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made the disclosure that requires all such features, and multiple such features may be combined as appropriate. Furthermore, in the attached drawings, the same reference numerals are given to the same or similar configurations, and redundant description thereof is omitted.

Japanese Patent Laid-Open No. 2014-166762 does not mention controlling multilayer printing so as to output a printed matter equivalent to that in a case of performing double-sided printing, based on presence/absence of data corresponding to each of a front surface and a back surface in print data for which double-sided printing is designated.

According to the present disclosure, it is possible to control multilayer printing so as to output a printed matter equivalent to that in a case of performing double-sided printing, based on presence/absence of data corresponding to each of a front surface and a back surface in print data for which double-sided printing is designated.

### <Basic Configuration of Apparatus>

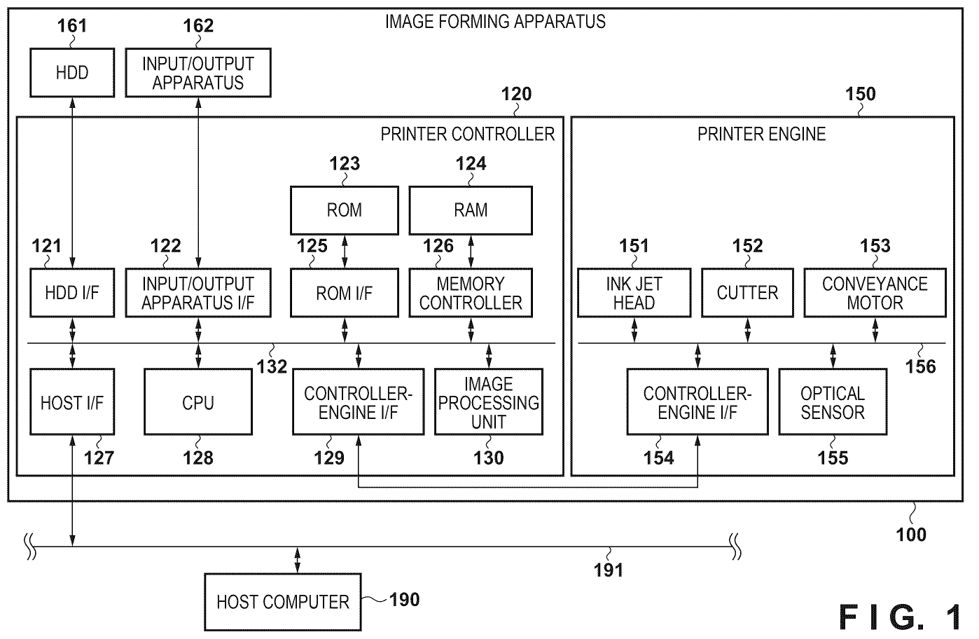

FIG. 1 is a block diagram illustrating a configuration of an image forming apparatus according to the present embodiment. Note that in the present embodiment, a printing apparatus having only a printing function will be described as the image forming apparatus, but the image forming apparatus is not limited to this. For example, the image forming apparatus may be configured to further include a reading apparatus that reads an image on a document and to function as a copy machine, or may be configured as a multi-function peripheral (MFP) to which other functions have been added.

In FIG. 1, an image forming apparatus 100 is configured to include a printer controller 120, a printer engine 150, an HDD 161, and an input/output apparatus 162. The image forming apparatus 100 can be connected to a host computer 190 via a network 191. The printer controller 120 includes an HDD interface (I/F) 121, an input/output apparatus I/F 122, a ROM I/F 125, and a memory controller 126. The printer controller 120 includes a host I/F 127, a central processing unit (CPU) 128, a controller-engine interface 129, and an image processing unit 130. These are connected to one another via a system bus 132. Furthermore, the printer controller 120 includes a ROM 123 and a RAM 124. The ROM 123 is, for example, a flash ROM, and is connected to the system bus 132 via the ROM I/F 125. The RAM 124 is connected to the system bus 132 via the memory controller 126.

The CPU 128 is a central processing unit in the form of a microprocessor (microcomputer), and controls the entire operation of the image forming apparatus 100 by execution of a program or activation of hardware. The ROM 123 stores programs to be executed by the CPU 128 and various data necessary for the operation of the image forming apparatus 100. The RAM 124 is used as a work area of the CPU 128, is used as a temporary storage area of various reception data, and stores various setting data.

The image processing unit 130 executes various types of image processing. For example, the image processing unit 130 performs processing of developing (converting) print data (e.g., data expressed in a page description language) handled by the image forming apparatus 100 into image data (e.g., bitmap image data). In the present embodiment, data obtained by executing image processing by the image processing unit 130 on print data received from the host computer 190 or an external server is called image data. The image processing unit 130 converts a color space (e.g., YCbCr) defined by input print data into a standard RGB color space (e.g., sRGB). As image processing of the image processing unit 130, various types of processing such as resolution conversion to the number of pixels that can be processed by the image forming apparatus 100, image analysis, and image correction may be executed. The image data obtained by the image processing of the image processing unit 130 is stored in the RAM 124 or the HDD 161.

The printer engine 150 is a printing unit that forms an image. The printer engine 150 includes an ink jet printhead 151 (hereinafter, the printhead 151), a cutter unit 152, a conveyance motor 153, a controller-engine interface 154 with the printer controller 120, and an optical sensor 155. Those parts are connected to one another via a system bus 156.

The printhead 151 is a printing unit that forms an image on a print medium based on image data. The printhead 151 holds, for example, nozzle rows for a plurality of colors, synchronizes with conveyance of the print medium, ejects ink from the printhead 151, and forms an image on the print medium. Note that as the image forming apparatus 100, a printing apparatus of an ink jet printing method using ink as a printing material will be described as an example, but the present disclosure is not limited to this. As the image forming apparatus 100, printing apparatuses of various printing methods such as an electrophotographic system such as a thermal printer (sublimation type, thermal transfer type, and the like), a dot impact printer, a light emitting diode (LED) printer, and a laser printer may be used. In the present embodiment, the color of the printing material usable in the image forming apparatus 100 includes white as a specific color used for making (shielding) the printing material invisible from the other surface when viewed from one surface of the print medium. In the present embodiment, a print medium having transparency, such as a transparent film or glass, is used as the print medium. In the present embodiment, the print medium is assumed to be a print medium having a roll shape, but may be a print medium having a cut shape.

The cutter unit 152 is a mechanism that cuts a print medium having a roll shape (roll sheet). The cutter unit 152 cuts the roll sheet after printing to a predetermined length. Note that in the case of the type of print medium in which paper dust scatters when cut by the cutter unit 152, a setting for printing a cut waste reduction line at a cut position may be stored in the ROM 123 in order to prevent paper dust from scattering at the time of cutting. Other than the setting of the cut waste reduction line, the operation setting of the cutter unit 152 may be stored in the ROM 123 for each type. In the case of a type that cannot be cut using the cutter unit 152, a setting (user cut) for not moving the cutter unit 152 may be stored in the ROM 123 in order for the user to cut with scissors. In the case of a type in which a straight line to be cut is bent unless the user cuts the roll sheet while pressing it, a setting (eject cut) in which the cutter unit 152 is operated by the user operation may be stored in the ROM 123. In the case of a type in which settings for the user cut and the eject cut are not performed, a setting (automatic cut) for automatic cutting by the cutter unit 152 may be stored in the ROM 123.

The conveyance motor 153 is a motor for driving a conveyance roller that conveys the roll sheet, and is controlled by the CPU 128. The optical sensor 155 is a measuring mechanism for measuring an attribute value of the print medium, and is a reflection type optical sensor configured to include an LED as a light emitting element, a specular reflection light receiving element, and a diffusion light receiving element. Using the optical sensor 155, the image forming apparatus 100 measures, as attribute values, the intensities of the specular reflection light and the diffuse reflection light of the print medium present on a platen, the thickness of the print medium, and the like.

The input/output apparatus 162 includes a hardware key and a panel for the user to perform various operations, and a display unit for displaying various pieces of information to the user. The input/output apparatus 162 may notify the user of information by outputting a sound (buzzer, sound, or the like) based on sound information from a voice generator. At the time of feeding, the user selects the type of print medium using the input/output apparatus 162, whereby the image forming apparatus 100 performs conveyance control of the print medium based on setting information for each type.

The HDD 161 is a nonvolatile storage area, and stores a program for the CPU 128 to execute, print data, and setting information necessary for various operations of the image forming apparatus 100. Note that in place of the HDD 161, another mass storage device such as a flash memory may be used.

Note that in the present embodiment, the input/output apparatus 162 is configured to exist inside the image forming apparatus 100, but the present disclosure is not limited to this. For example, the input/output apparatus 162 may be connected as an external configuration via the network 191. The host computer 190 may operate as the input/output apparatus 162. Other than the input/output apparatus 162, another input/output apparatus may be further connectable to the image forming apparatus 100 via the network 191 or the like.

The host computer 190 is an external apparatus serving as a supply source of print data, for example, and has a printer driver installed therein. The print data is data created by an application on the host computer 190 and transmitted to the image forming apparatus 100 via the printer driver. In the present embodiment, as an example, a print job including print data, print setting information, and a command is transmitted from the host computer 190 to the image forming apparatus 100. The application is an application that can designate single-sided printing or double-sided printing, and the print setting information is information set by the application. However, setting for single-sided printing, double-sided printing, and the like may be performed by the printer driver, and the print setting information may be information set by the printer driver.

In place of the host computer 190, for example, a data providing apparatus serving as a supply source of print data, such as a reader, a digital camera, or a smartphone for reading an image, may be provided. The image forming apparatus 100 and the host computer 190 can communicate with each other via the network 191. The network 191 is a wired network, a wireless network, or a network in which both are mixed.

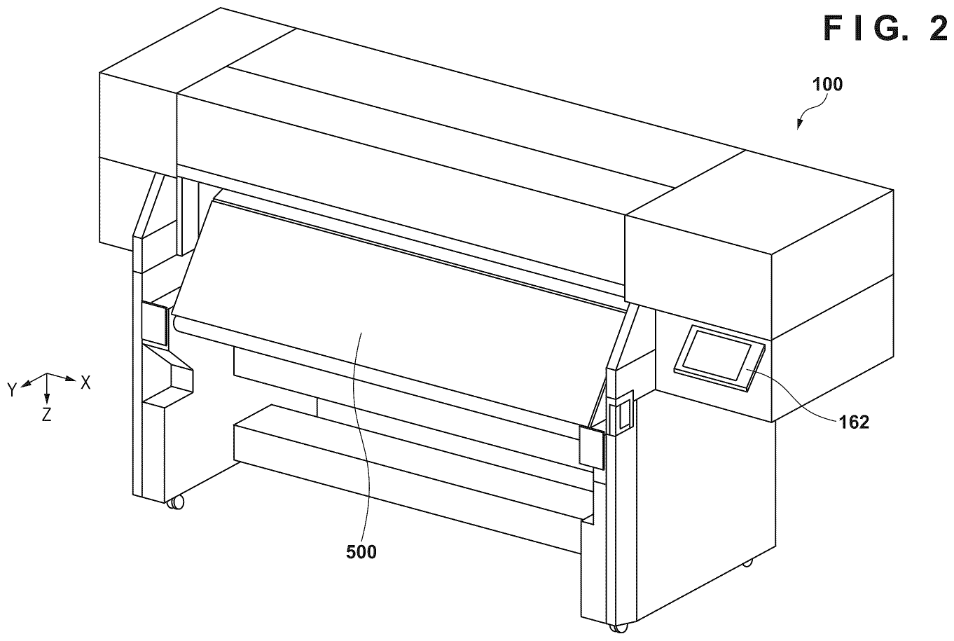

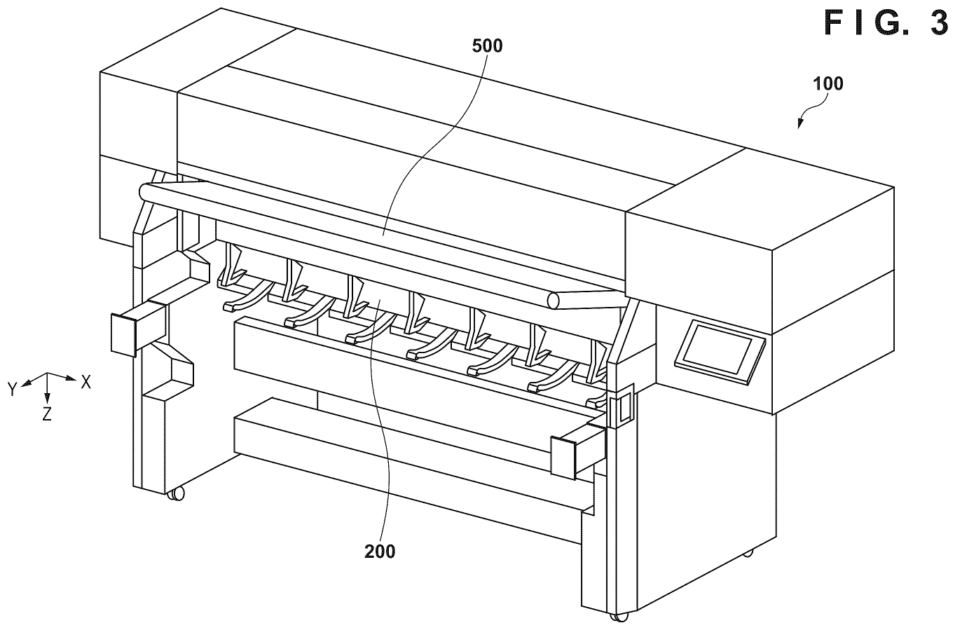

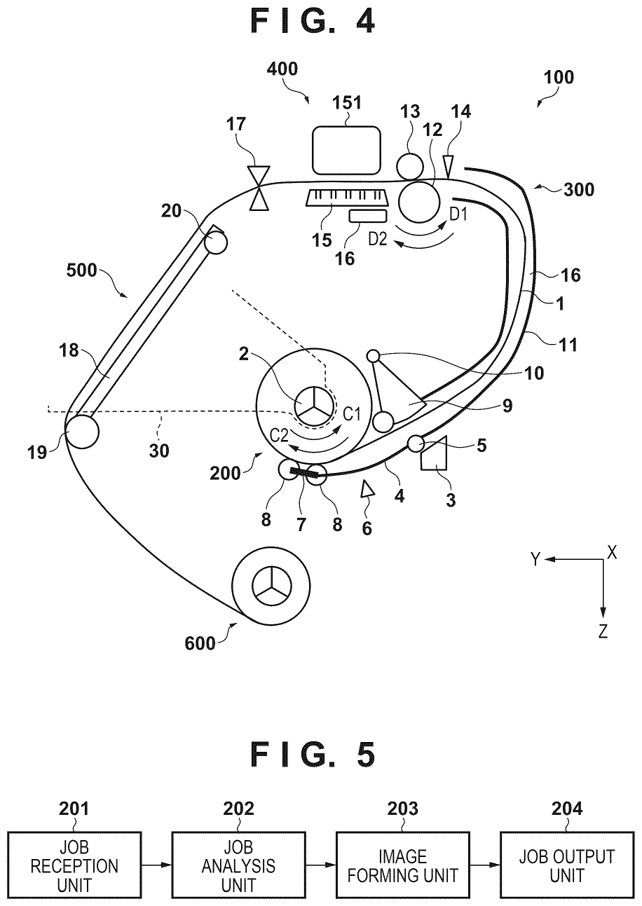

FIG. 2 is a view illustrating an appearance of the image forming apparatus 100. The image forming apparatus 100 is configured to be able to feed a roll sheet in which a sheet is wound in a roll shape and to take up a printed sheet. The input/output apparatus 162 includes a hardware key and a panel for the user to perform various operations, and a display unit for displaying various pieces of information to the user. The input/output apparatus 162 may notify the user of information by outputting a sound (buzzer, sound, or the like) based on sound information from a voice generator. At the time of feeding, the user selects the type of print medium using the input/output apparatus 162, whereby the image forming apparatus 100 performs conveyance control of the print medium based on setting information for each type. When a discharging guide unit 500 is in an open state, the user can set a roll sheet in a roll set unit 200 illustrated in FIG. 3. FIG. 3 is a perspective view of the image forming apparatus 100 at the time of setting a roll sheet. When the discharging guide unit 500 is in a closed state, the sheet drawn out from the roll sheet set in the roll set unit 200 reaches a print unit 400 via a sheet conveyance unit 300 as illustrated in FIG. 4, and is discharged to the discharging guide unit 500 after an image is printed in the print unit 400. Using various switches and the like included in the input/output apparatus 162, the user can input, on the input/output apparatus 162, various commands and the like for the image forming apparatus 100, such as size designation of the roll sheet and setting of the type of the roll sheet.

FIG. 4 is a schematic cross-sectional view of the periphery of the print mechanism of the image forming apparatus 100. A sheet 1 drawn out from the roll sheet set in the roll set unit 200 is taken up by a take-up unit 600. The sheet 1 drawn out from the roll sheet set in the roll set unit 200 is conveyed to the print unit 400 that can print an image through the sheet conveyance unit 300. The print unit 400 forms (prints) an image on the sheet 1 by ejecting ink droplets from an ejection port (nozzle) of the printhead 151. The printhead 151 ejects ink droplets from the ejection ports using an ejection energy generating element such as an electrothermal conversion element (heater) or a piezo element. When the electrothermal conversion element is used, the ink is foamed by heat generation thereof, and ink droplets are ejected from the ejection port using the foaming energy. The printhead 151 may be a printhead driven by, for example, a serial scan method, a full-line method, or the like. In the case of the serial scan method, an image is formed on the print medium by performing conveyance operation of the sheet 1 and scanning the printhead 151 in a direction intersecting the conveyance direction of the sheet 1. In the case of the full-line method, the long printhead 151 extending in a direction intersecting the conveyance direction of the sheet 1 is used, and an image is formed on the print medium while continuously conveying the sheet 1.

A roll support member 2 having a shaft shape is inserted into a hollow hole portion of the roll sheet, and the roll support member 2 is driven in the forward rotation and the reverse rotation by a roll drive motor. By this, the roll sheet has the central portion thereof held, and is rotated forward or backward in directions of arrows C1 and C2. The roll set unit 200 includes a driving unit 3, an arm member (moving body) 4, an arm rotation shaft 5, a first sheet sensor 6, a swing member 7, a driven rotation body (pressure contact body) 8, a separation flapper (upper guide body) 9, and a flapper rotation shaft 10.

A sheet feed side conveyance guide 11 guides the sheet 1 to the print unit 400 while guiding the front and back surfaces of the sheet 1 drawn out from the roll set unit 200. A conveyance roller 12 is rotated forward or backward in directions of arrows D1 and D2 by a conveyance roller driving motor. A nip roller 13 can perform driven rotation according to rotation of the conveyance roller 12, is separable from and in pressure contact with the conveyance roller 12 by a nip roller separation motor (not illustrated), and can adjust a nip force. The conveyance roller 12 starts rotation when a second sheet sensor 14 detects the leading end of the sheet 1. The conveyance speed of the sheet 1 by the conveyance roller 12 is set to be higher than the drawing speed of the sheet 1 by rotation of the roll sheet, whereby the sheet 1 is applied with the back tension, and the sheet 1 can be conveyed in a stretched state. As a result, it is possible to prevent slack of the sheet 1, and suppress generation of a crease of the sheet 1 and generation of a conveyance error.

A platen 15 of the print unit 400 suctions the back surface of the sheet 1 through a suction hole provided in the platen 15 by the negative pressure generated by a suction fan 16. This can regulate the position of the sheet 1 along the platen 15, and can print the image with high accuracy by the printhead 151. A cutter 17 cuts the sheet 1 on which an image is printed.

A discharging side conveyance guide 18 provided in the discharging guide unit 500 guides the sheet 1 to the take-up unit 600 while guiding the back surface of the sheet 1 drawn out from the print unit 400. Here, by fixing the leading end of the sheet 1 to a paper tube set in the take-up unit 600 and rotating the paper tube set according to the conveyance speed of the conveyance roller 12, it is possible to continuously take up the sheet 1 printed by the print unit 400. By providing a driven roller 19 at a take-up side end portion of the discharging side conveyance guide 18, damage is prevented from occurring to the sheet 1 due to bending at the driven roller 19. Furthermore, the conveyance resistance at a bent portion is reduced, and large bending is prevented from being generated between the conveyance roller 12 and the driven roller 19. By configuring the sheet 1 to follow the discharging side conveyance guide 18, it is possible to heat the discharging side conveyance guide 18 by a heating unit (not illustrated) and to assist in thermally fixing, onto the sheet 1, the ink ejected by the print unit 400. The discharging side conveyance guide 18 and the driven roller 19 can be rotated about a discharging guide rotation shaft 20. By this, when the roll sheet is attached to and detached from the roll set unit 200, by retracting the discharging side conveyance guide 18 and the driven roller 19 upward by rotation as illustrated in FIG. 3, the roll sheet can be set without interfering with the discharging guide unit 500.

Hereinafter, processing in a case where the image forming apparatus 100 receives a print job for which double-sided printing is designated will be described. In the present embodiment, without considering multilayer printing on an application side, it is possible to control multilayer printing so as to output a printed matter equivalent to that in a case of performing double-sided printing, based on presence/absence of data corresponding to each of a front surface and a back surface in print data for which double-sided printing is designated.

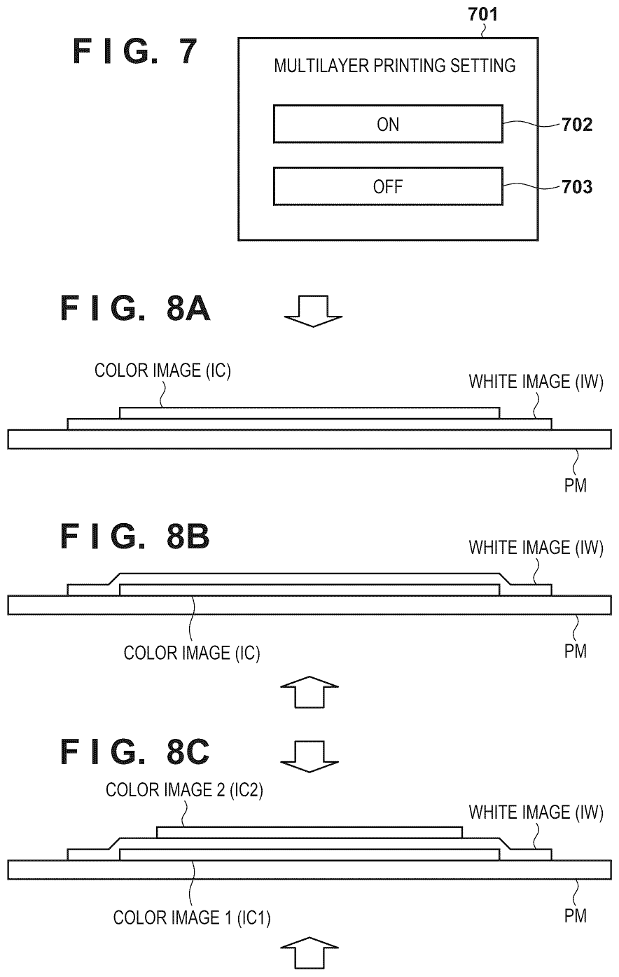

FIG. 5 is a view illustrating a functional block configuration of the printer controller 120. The printer controller 120 includes a job reception unit 201, a job analysis unit 202, an image forming unit 203, and a job output unit 204. The job reception unit 201 acquires by receiving the print job from the host computer 190 or receiving the print job from a server (not illustrated) via the network 191. The job analysis unit 202 analyzes print setting information included in the print job acquired by the job reception unit 201. The image forming unit 203 generates image data by executing image processing by the image processing unit 130 on the print data. In generation of image data, development to an image buffer is performed. The job output unit 204 outputs the generated image data to the printer engine 150. The printer engine 150 forms an image on the print medium based on the image data. When the printer engine 150 is set so as to execute multilayer printing on a screen of FIG. 7 described later, an image is formed by multilayer printing.

In the present embodiment, the image forming unit 203 handles, as hierarchical data, page data included in the print data, by assigning the page data to each hierarchical layer in the multilayer printing. Specifically, for example, when double-sided printing is set by the print setting information, the page data corresponding to the front surface and the page data corresponding to the back surface included in the print data are assigned to hierarchical layers (a first hierarchical layer and a third hierarchical layer described later), respectively, in the multilayer printing. Then, the data after being assigned to the respective hierarchical layers is developed in the image buffer, whereby image data is generated.

Here, a printed matter in a case where multilayer printing is performed in the image forming apparatus 100 will be described.

FIGS. 8A to 8C are views for describing a printed matter in the case where the multilayer printing is performed. FIGS. 8A to 8C illustrate a print pattern in which a color image and a white image are printed in a multilayer. FIG. 8A illustrates a print pattern in which a white image IW (first hierarchical layer) is formed on a transparent film as a print medium PM and a color image IC (second hierarchical layer) is formed on the white image IW. In the present print pattern, the observer observes the printed matter from above in the drawing (illustrated by the arrow). In the present embodiment, the present print pattern is a printed matter of a case where multilayer printing is performed in a case where double-sided printing is set and in a case where an image is arranged only on the front surface. That is, the color image IC (second hierarchical layer) corresponds to the image arranged only on the front surface.

FIG. 8B illustrates a print pattern in which the color image IC (first hierarchical layer) is formed on a transparent film as the print medium PM, and the white image IW (second hierarchical layer) is formed on the color image IC (first hierarchical layer). In the present print pattern, the observer observes the printed matter from below in the drawing (illustrated by the arrow). In the present embodiment, the present print pattern is a printed matter of a case where multilayer printing is performed in a case where double-sided printing is set and in a case where an image is arranged only on the back surface. That is, the color image IC (first hierarchical layer) corresponds to the image arranged only on the back surface.

FIG. 8C illustrates a print pattern in which a color image IC1 (first hierarchical layer) is formed on a transparent film as the print medium PM, the white image IW (second hierarchical layer) is formed on the color image IC1 (first hierarchical layer), and a color image IC2 (third hierarchical layer) is further formed on the white image IW (second hierarchical layer). In the present printing pattern, the observer observes the printed product from above and below in the drawing (illustrated by the arrows). In the present embodiment, the present print pattern is a printed matter of a case where multilayer printing is performed in a case where double-sided printing is set and in a case where images are arranged on both surfaces (the front surface and the back surface). That is, the color image IC1 (first hierarchical layer) corresponds to the image arranged on the back surface, and the color image IC2 (third hierarchical layer) corresponds to the image arranged on the front surface.

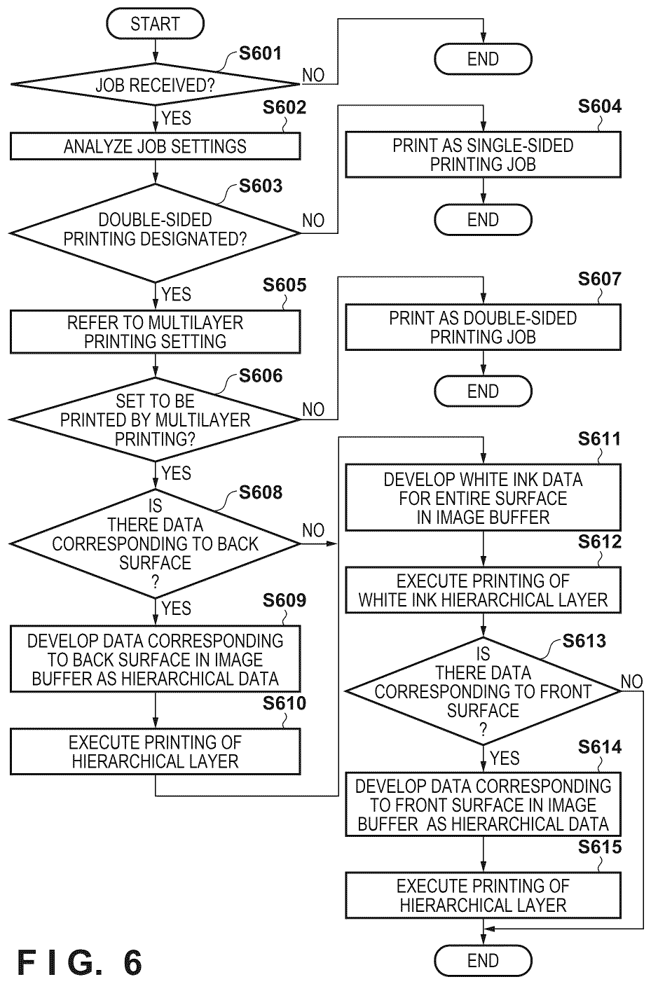

FIG. 6 is a flowchart showing processing of the printer controller 120 when receiving a print job. The processing of FIG. 6 is realized, for example, by the CPU 128 reading, into the RAM 124, a program stored in the ROM 123 and executing the program.

In S601, the printer controller 120 receives the print job transmitted from the host computer 190 by the job reception unit 201. In S602, the printer controller 120 analyzes the print setting information included in the print job by the job analysis unit 202.

In S603, the printer controller 120 determines whether or not double-sided printing is designated in the print setting information by the job analysis unit 202. If it is determined that double-sided printing is not designated, the process proceeds to S604. In S604, the printer controller 120 executes the print job as a single-sided printing job, and then ends the processing of FIG. 6. On the other hand, if it is determined that double-sided printing is designated, the process proceeds to S605. In S605, the printer controller 120 refers to the multilayer printing setting information set via the input/output apparatus 162 by the job analysis unit 202.

FIG. 7 is a view illustrating an example of a multilayer printing setting screen. A multilayer printing setting screen 701 is a screen displayed on the input/output apparatus 162, and the user selects and sets whether or not to perform multilayer printing as a main body setting in advance. In other words, the multilayer printing setting screen 701 can also be said to be a screen for setting whether to enable or disable the multilayer printing. The multilayer printing setting screen 701 includes a button 702 for receiving selection to perform multilayer printing and a button 703 for receiving selection not to perform multilayer printing. Then, the printer controller 120 controls the print processing of the print job for which double-sided printing is designated, based on the setting content of the multilayer printing setting screen 701. When the button 703 is selected, the print job for which double-sided printing is designated is printed as a double-sided printing job. That is, in that case, multilayer printing is not performed. On the other hand, when the button 702 is selected, the print job for which double-sided printing is designated is printed as a multilayer printing job. That is, in that case, multilayer printing is performed.

In S606, the printer controller 120 determines whether or not to perform printing by multilayer printing based on the setting content of the multilayer printing setting screen 701. If it is determined that printing is not to be performed by multilayer printing, the process proceeds to S607. In S607, the printer controller 120 executes the print job as a double-sided printing job, and then ends the processing of FIG. 6. On the other hand, if it is determined that printing is to be performed by multilayer printing, the process proceeds to S608.

First, processing of a case (case 1) in which multilayer printing is performed based on print data in which page data is assigned to each of the front surface and the back surface by setting of double-sided printing will be described.

In S608, the printer controller 120 determines whether or not page data is assigned to the back surface by the image forming unit 203. The determination of whether or not the page data is assigned to the back surface is made based on whether or not a pixel exists in an area corresponding to the back surface of the print medium. If at least one pixel exists, it is determined that page data is assigned to the back surface, and if no pixel is present (what is called white paper), it is determined that page data is not assigned to the back surface. In the present case, since the page data is assigned to the back surface, the process proceeds from S608 to S609. In other words, the processing of S608 can be said to be processing of determining whether or not page data corresponding to the back surface exists.

In S609, the printer controller 120 develops the page data assigned to the back surface in the image buffer as data of the first hierarchical layer in the multilayer printing by the image forming unit 203. Then, in S610, the printer controller 120 controls the printer engine 150 so as to perform multilayer printing of the first hierarchical layer by the job output unit 204. This corresponds to printing of the color image IC1 (first hierarchical layer) of FIG. 8C.

In S611, the printer controller 120 develops the data of the second hierarchical layer for applying white ink to an entire printable area in the image buffer by the image forming unit 203. Here, the printable area is an internal area in which a predetermined margin is secured from the end portion of the print medium due to the specifications of the image forming apparatus 100. In step S612, the printer controller 120 controls the printer engine 150 so as to perform multilayer printing of the white ink hierarchical layer (second hierarchical layer) by the job output unit 204. This corresponds to printing of the white image IW (second hierarchical layer) of FIG. 8C.

In S613, the printer controller 120 determines whether or not page data is assigned to the front surface by the image forming unit 203. The determination of whether or not the page data is assigned to the front surface is made based on whether or not a pixel exists in an area corresponding to the front surface of the print medium. If at least one pixel exists, it is determined that page data is assigned to the front surface, and if no pixel is present (what is called white paper), it is determined that page data is not assigned to the front surface. In the present case, since the page data is assigned to the front surface, the process proceeds from S613 to S614. In other words, the processing of S613 can be said to be processing of determining whether or not page data corresponding to the front surface exists.

In S614, the printer controller 120 develops the page data assigned to the front surface in the image buffer as data of the third hierarchical layer in the multilayer printing by the image forming unit 203. Then, in S615, the printer controller 120 controls the printer engine 150 so as to perform multilayer printing of the third hierarchical layer by the job output unit 204. This corresponds to printing of the color image IC2 (third hierarchical layer) of FIG. 8C. After S615, the process of FIG. 6 ends.

As described above, according to the present embodiment, the page data assigned to the back surface in the print data is assigned to the first hierarchical layer, and the page data assigned to the front surface is assigned to the third hierarchical layer, whereby the print pattern as in FIG. 8C can be easily realized. That is, by the multilayer printing, it is possible to perform control so as to output a printed matter similar to that in double-sided printing in which page data is assigned to the front surface and the back surface.

Next, processing of a case (case 2) in which multilayer printing is performed based on print data in which page data is assigned only to the back surface will be described.

Since S601 to S612 are the same as those in the description in case 1, the description thereof will be omitted.

In S613, the printer controller 120 determines whether or not page data is assigned to the front surface by the image forming unit 203. The determination of whether or not the page data is assigned to the front surface is made based on whether or not a pixel exists in an area corresponding to the front surface of the print medium. If at least one pixel exists, it is determined that page data is assigned to the front surface, and if no pixel is present (what is called white paper), it is determined that page data is not assigned to the front surface. In the present case, since no page data is assigned to the front surface, the processing of FIG. 6 ends after S613. As a result of the processing of case 2, the print pattern as in FIG. 8B is realized.

As described above, according to the present embodiment, the page data assigned to the back surface in the print data is assigned to the first hierarchical layer, whereby the print pattern as in FIG. 8B can be easily realized. That is, by the multilayer printing, it is possible to perform control so as to output a printed matter similar to that in double-sided printing in which page data is assigned only to the back surface.

Next, processing of a case (case 3) in which multilayer printing is performed based on print data in which page data is assigned only to the front surface will be described.

Since S601 to S607 are the same as those in the description in case 1, the description thereof will be omitted.

In S608, the printer controller 120 determines whether or not page data is assigned to the back surface by the image forming unit 203. The determination of whether or not the page data is assigned to the back surface is made based on whether or not a pixel exists in an area corresponding to the back surface of the print medium. If at least one pixel exists, it is determined that page data is assigned to the back surface, and if no pixel is present (what is called white paper), it is determined that page data is not assigned to the back surface. In the present case, since no page data is assigned to the back surface, the process proceeds from S608 to S611.

Since S611 and S612 are the same as those in the description in case 1, the description thereof will be omitted. However, unlike case 1, since S609 and S610 are not performed, print of the color image IC1 of FIG. 8C is not performed.

In S613, the printer controller 120 determines whether or not page data is assigned to the front surface by the image forming unit 203. The determination of whether or not the page data is assigned to the front surface is made based on whether or not pixel data exists in an area corresponding to the front surface of the print medium. If at least one pixel exists, it is determined that page data is assigned to the front surface, and if no pixel is present (what is called white paper), it is determined that page data is not assigned to the front surface. In the present case, since the page data is assigned to the front surface, the process proceeds from S613 to S614.

Since S614 and S615 are the same as those in the description in case 1, the description thereof will be omitted. As a result of the processing of case 3, the print pattern as in FIG. 8A is realized.

As described above, according to the present embodiment, the page data assigned to the front surface in the print data is assigned to the third hierarchical layer, whereby the print pattern as in FIG. 8A can be easily realized. That is, by the multilayer printing, it is possible to perform control so as to output a printed matter similar to that in double-sided printing in which page data is assigned only to the front surface.

In the present embodiment, it has been described that the white ink is used as the ink applied to the second hierarchical layer of FIG. 8C. However, the ink is not limited to the white ink, and ink of another color may be used as long as the ink is for the purpose of shielding an image on the other surface. Ink of black color may be used as the ink applied to the second hierarchical layer of FIG. 8C, for example. Ink of another color having a light shielding property may be used.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-090921, filed Jun. 4, 2024, which is hereby incorporated by reference herein in its entirety.

What is claimed is:

1. An image forming apparatus comprising:
at least one memory and at least one processor which function as:
an acquisition unit configured to acquire print data and print setting information;
a data control unit configured to control assignment to each hierarchical layer in multilayer printing based on presence/absence of data corresponding to at least any of a front surface and a back surface in the print data when double-sided printing is set for the print data in the print setting information;
a generation unit configured to generate image data by executing image processing on hierarchical data on which the assignment is performed under control by the data control unit; and
a print control unit configured to control a print unit so as to perform printing by the multilayer printing on a print medium based on the image data generated by the generation unit.

2. The image forming apparatus according to claim 1, wherein the data control unit obtains first hierarchical data by assigning data corresponding to the back surface to a first hierarchical layer.

3. The image forming apparatus according to claim 2, wherein when the multilayer printing is performed by the print unit based on the first hierarchical data, an image based on the first hierarchical data is printed on the print medium.

4. The image forming apparatus according to claim 2, wherein the data control unit obtains second hierarchical data by assigning data for printing with a printing material of a specific color to a second hierarchical layer.

5. The image forming apparatus according to claim 4, wherein when the multilayer printing is performed by the print unit based on the second hierarchical data, the printing material of the specific color is applied so as to overlap with an image printed based on the first hierarchical data.

6. The image forming apparatus according to claim 4, wherein the data control unit obtains third hierarchical data by assigning data corresponding to the front surface to a third hierarchical layer.

7. The image forming apparatus according to claim 6, wherein when the multilayer printing is performed by the print unit based on the third hierarchical data, an image based on the third hierarchical data is printed so as to overlap with the printing material of the specific color applied based on the second hierarchical data.

8. The image forming apparatus according to claim 1,
wherein when there is no data corresponding to the back surface and there is data corresponding to the front surface in the print data,
the data control unit obtains first hierarchical data by assigning data for printing with a printing material of a specific color to a first hierarchical layer.

9. The image forming apparatus according to claim 8, wherein when the multilayer printing is performed by the print unit based on the first hierarchical data, the printing material of the specific color is applied on the print medium.

10. The image forming apparatus according to claim 8, wherein the data control unit obtains second hierarchical data by assigning data corresponding to the front surface to a second hierarchical layer.

11. The image forming apparatus according to claim 10, wherein when the multilayer printing is performed by the print unit based on the second hierarchical data, an image based on the second hierarchical data is printed so as to overlap with the printing material of the specific color applied based on the first hierarchical data.

12. The image forming apparatus according to claim 1,
wherein the at least one memory and the at least one processor further function as
a setting unit configured to set whether or not to execute the multilayer printing, and
when execution of the multilayer printing is set by the setting unit, control by the data control unit is performed.

13. The image forming apparatus according to claim 4, wherein the specific color includes at least any of white and black.

14. The image forming apparatus according to claim 4, wherein the specific color is a color used for shielding an image.

15. The image forming apparatus according to claim 4, wherein the printing material is ink.

16. The image forming apparatus according to claim 1,
wherein the image forming apparatus includes the print unit,
the image processing includes development of the hierarchical data in an image buffer, and
the print unit performs printing based on image data generated based on the hierarchical data developed in the image buffer.

17. The image forming apparatus according to claim 1, wherein the print medium is a print medium having transparency.

18. The image forming apparatus according to claim 1, wherein the print data and the print setting information are print data and print setting information generated by an apparatus outside of the image forming apparatus and transmitted to the image forming apparatus.

19. A control method executed in an image forming apparatus, the control method comprising:
acquiring print data and print setting information;
controlling assignment to each hierarchical layer in multilayer printing based on presence/absence of data corresponding to at least any of a front surface and a back surface in the print data when double-sided printing is set for the print data in the print setting information;
generating image data by executing image processing on hierarchical data on which the assignment is performed under the control; and
controlling a print unit so as to perform printing by the multilayer printing on a print medium based on the image data generated.

20. A non-transitory computer-readable storage medium that stores one or more programs including instructions, which when executed by at least one memory and at least one processor of an image forming apparatus, cause the image forming apparatus to:
acquire print data and print setting information;
control assignment to each hierarchical layer in multilayer printing based on presence/absence of data corresponding to at least any of a front surface and a back surface in the print data when double-sided printing is set for the print data in the print setting information;
generate image data by executing image processing on hierarchical data on which the assignment is performed under the control; and
control a print unit so as to perform printing by the multilayer printing on a print medium based on the image data generated.
